(19) United States
(12) Patent Application Publication
(10) Pub. No.: US 2025/0063151 A1
(43) Pub. Date: Feb. 20, 2025

(54) METHOD AND APPARATUS FOR VIDEO CODING USING ADAPTIVE CHROMA SPACE CONVERSION

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Byeung Woo Jeon, Seongnam-si (KR); Jee Yoon Park, Seoul (KR); Jee Hwan Lee, Gwacheon-si (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/817,821

(22) Filed: Aug. 28, 2024

Related U.S. Application Data
(63) Continuation of application No. PCT/KR2023/002514, filed on Feb. 22, 2023.

(30) Foreign Application Priority Data
Mar. 8, 2022 (KR) 10-2022-0029104
Feb. 17, 2023 (KR) 10-2023-0021661

(51) Int. Cl. H04N 9/67; H04N 19/159; H04N 19/176; H04N 19/186

(52) U.S. Cl. CPC H04N 9/67; H04N 19/159; H04N 19/176; H04N 19/186

(57) ABSTRACT

A video coding method and apparatus select an optimal method from among various chrominance space conversion methods for the current chroma block's original signals, predictors, or residual signals, based on correlations between chroma channel components. The video coding method and the apparatus perform chrominance space conversion of Cb and Cr components using the selected method.

### CROSS REFERENCE TO RELATED APPLICATIONS

This application is a continuation of International Application No. PCT/KR2023/002514 filed on Feb. 22, 2023, which claims priority to and the benefit of Korean Patent Application No. 10-2022-0029104 filed on Mar. 8, 2022, and Korean Patent Application No. 10-2023-0021661, filed on Feb. 17, 2023, the entire contents of each of which are incorporated herein by reference.

### TECHNICAL FIELD

The present disclosure relates to a video coding method and an apparatus using adaptive chroma space conversion.

### BACKGROUND

The statements in this section merely provide background information related to the present disclosure and do not necessarily constitute prior art.

When a video is encoded in blocks, the encoder first performs a prediction to generate a predictor and then subtracts the predictor from the original signals to generate residual signals. The residual signals are then transformed into frequency-domain signals by using a transform technique, which concentrates the energy within the block into the low-frequency region, making the transformed residual signals easier to encode. The encoder selects and uses the appropriate transform technique for the residual signals, such as discrete cosine transform (DCT) or discrete sine transform (DST) to encode the target block, passing information about the selected transform techniques to the decoder.

According to the high efficiency video coding (HEVC) encoding technique, the residual signals of the luma (Y) channel are converted to frequency signals by a transform of Discrete Cosine Transform II (DCT-II) typically applied in the horizontal and vertical directions. When the target is a 4×4 block, it is subjected to the Discrete Sine Transform VII (DST-VII) transform or the Transform Skip Mode, where no transform is performed on the residual signals. However, the development of image compression technology leads to the development of various methods of generating predictors, which in practice can generate residual signals with various characteristics. Current state-of-the-art versatile video coding (VVC) technology incorporates new transforms such as Discrete Cosine Transform VIII (DCT-VIII), which allows more diverse transforms to be applied to the residual signals. In addition, the DST-VII transform and Transform Skip Mode, which were applied exclusively to 4×4 blocks previously, are now applied to other block sizes.

Meanwhile, the residual signals in the chroma channel of the video are typically transformed separately for the two components of the channel, the Cb and Cr components. For example, the encoder may apply a DCT-II transform to the residual signals of each chroma component in the horizontal and vertical directions or may apply a Transform Skip Mode to perform no transform. The encoder passes information to the decoder about the selected method per component. In addition to the regular methods described above, a transform may be performed by applying the Joint Coding for Chroma Residual (JCCR) technique to the chroma channel. JCCR technology takes advantage of the fact that the residual signals of the Cb and Cr components are inversely correlated (sign reversal) with each other. Namely, the encoder combines the residual signals of the Cb and Cr components into one and transmits the combined residual signal, whereas the decoder reconstructs the residual signals of both Cb and Cr components from the transmitted single residual signal. With regard to the combined single residual signal, the combining information may be transmitted as embedded in the syntax of the single component.

However, techniques such as those described above have the disadvantage of not being able to fully utilize the correlation that exists between the chroma channels. For example, although there is not as great a correlation between the Cb and Cr components as there is between the original RGB channels, there is still a significant degree of correlation between the Cb and Cr components. Applying separate transforms to each of the Cb and Cr components has the inefficiency of not being able to further utilize the significant correlation that remains between the Cb and Cr components. While the JCCR technique can reduce this inefficiency to some degree, the JCCR suffers from the technical limitation of significantly simplifying the correlation between the Cb and Cr components, which cannot accommodate all of the correlation between the chroma channels, as are present in a wide variety of forms in real-world images. These drawbacks lead to problems such as reduced coding efficiency and degraded quality of the decoded video. Therefore, there is a need to consider how to efficiently encode/decode chroma channels to enhance video quality and increase coding efficiency.

### SUMMARY

The present disclosure seeks to provide a video coding method and an apparatus for selecting an optimal method from among various chrominance space conversion methods for the current chroma block's original signals, predictors, or residual signals, based on correlations between chroma channel components to enhance video quality and increase video coding efficiency. The video coding method and the apparatus perform chrominance space conversion of the Cb and Cr components using the selected method.

At least one aspect of the present disclosure provides a method performed by a video decoding device for inversely converting a current chroma block. The method includes obtaining two converted signals that are generated by a chrominance space conversion by a video encoding device. The method also includes obtaining inverse conversion information corresponding to conversion information that is utilized for the chrominance space conversion. The method also includes generating signals in two chroma channels of the current chroma block from the two converted signals by applying an inverse chrominance space conversion that is based on the inverse conversion information.

Another aspect of the present disclosure provides a method performed by a video encoding device for converting a current chroma block. The method includes obtaining signals in two chroma channels of the current chroma block. The method also includes determining conversion information. The method also includes generating two converted signals from the signals in the two chroma channels by applying a chrominance space conversion that is based on the conversion information. The method also includes encoding the conversion information.

Yet another aspect of the present disclosure provides a computer-readable recording medium storing a bitstream generated by a video encoding method. The video encoding method includes obtaining signals in two chroma channels of a current chroma block. The video encoding method also includes determining conversion information. The video encoding method also includes generating two converted signals from the signals in the two chroma channels by applying a chrominance space conversion that is based on the conversion information. The video encoding method also includes encoding the conversion information.

As described above, the present disclosure provides a video coding method and an apparatus for selecting an optimal method from among various chrominance space conversion methods for the current chroma block's original signals, predictors, or residual signals, based on correlations between chroma channel components. The video coding method and the apparatus perform chrominance space conversion of the Cb and Cr components using the selected method. Thus, the video coding method and the apparatus improve video quality and increase video coding efficiency.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a process of encoding chroma components.

FIG. 7 is a diagram illustrating residual signals in a chroma channel after applying JCCR.

FIGS. 8 and 9 are diagrams illustrating a video encoding device applying chrominance space conversion and a video decoding device applying inverse chrominance space conversion, according to some embodiments of the present disclosure.

FIGS. 10 and 11 are diagrams illustrating a video encoding device applying chrominance space conversion and a video decoding device applying inverse chrominance space conversion, according to another embodiment of the present disclosure.

FIGS. 12 and 13 are diagrams illustrating a video encoding device applying chrominance space conversion and a video decoding device applying inverse chrominance space conversion, according to yet another embodiment of the present disclosure.

FIGS. 14A and 14B are diagrams illustrating a chrominance space conversion (CSC) and an inverse chrominance space conversion (ICSC), according to some embodiments of the present disclosure.

FIGS. 15A and 15B are diagrams illustrating a CSC and an ICSC, according to other embodiments of the present disclosure.

FIG. 16 is a flowchart of a method performed by a video encoding device for converting a current chroma block, according to at least one embodiment of the present disclosure.

FIG. 17 is a flowchart of a method performed by a video decoding device for inversely converting a current chroma block, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

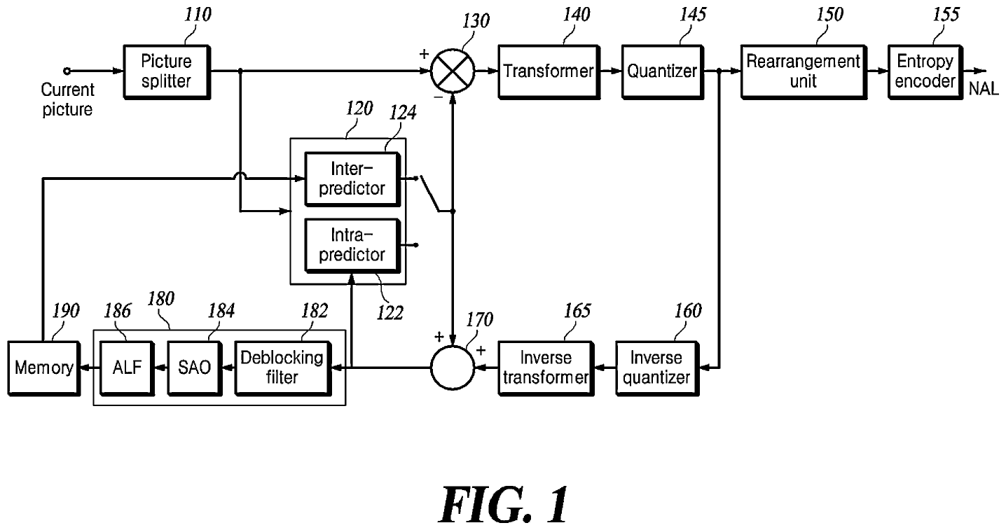

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

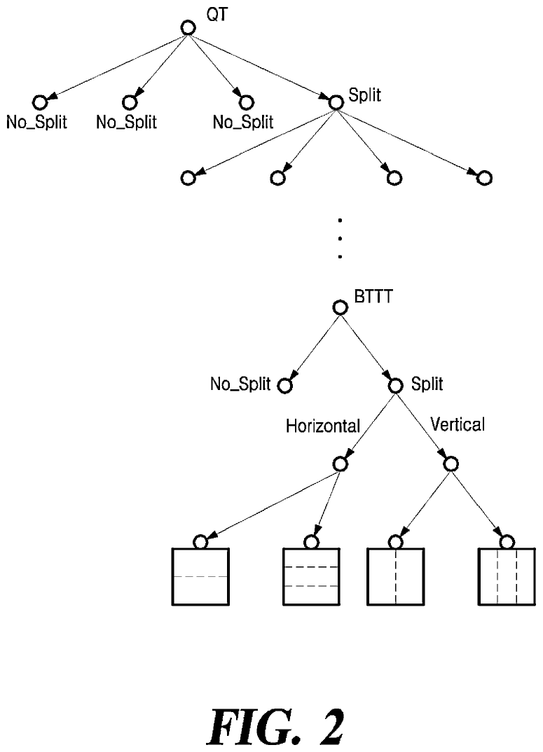

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

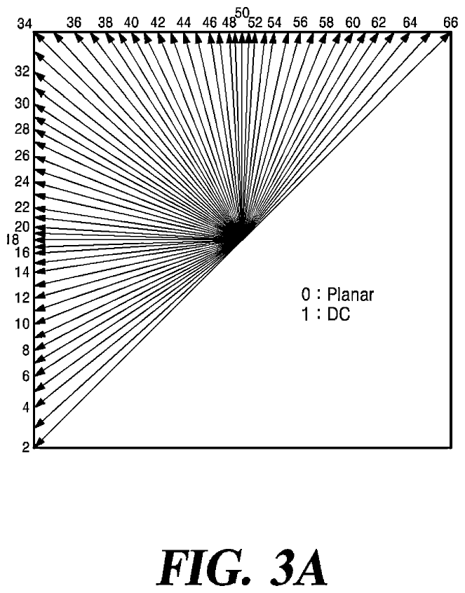

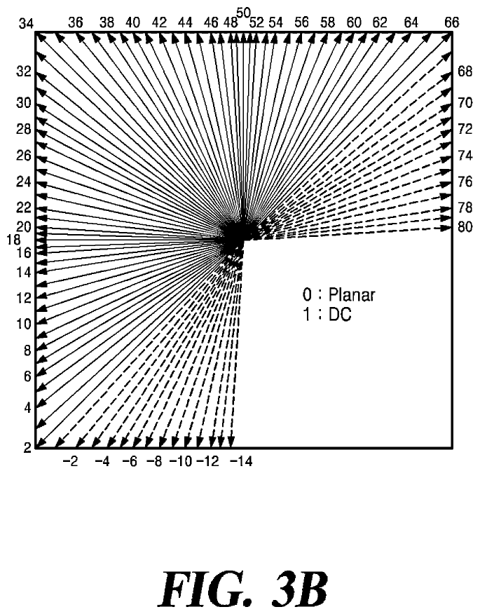

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

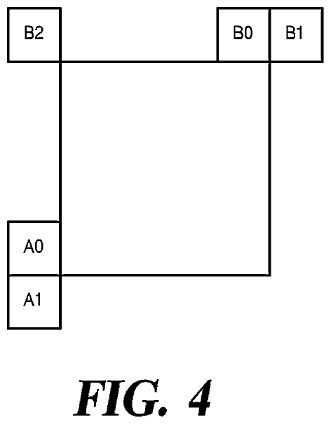

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

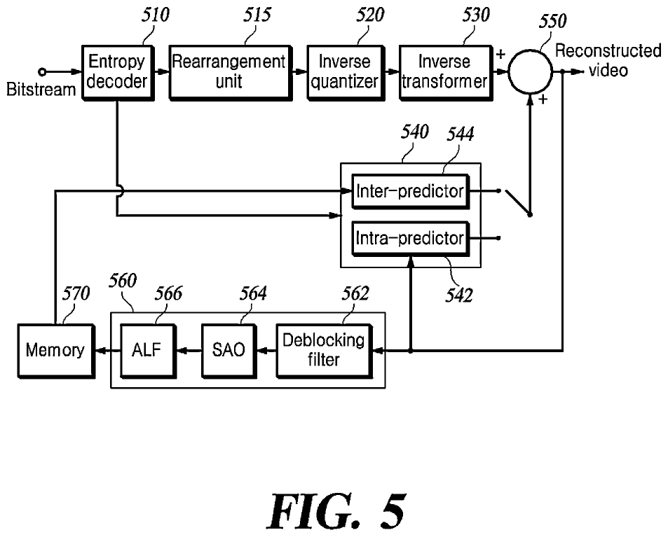

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for selecting an optimal method from among various chrominance space conversion methods for the current chroma block's original signals, predictors, or residual signals, based on correlations between chroma channel components. The video coding method and the apparatus perform chrominance space conversion of Cb and Cr components using the selected method.

The following embodiments may be performed by the video encoding device. The following embodiments may also be performed by the video decoding device.

The video encoding device in the encoding of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with decoding the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

### I. Encoding of Chroma Component

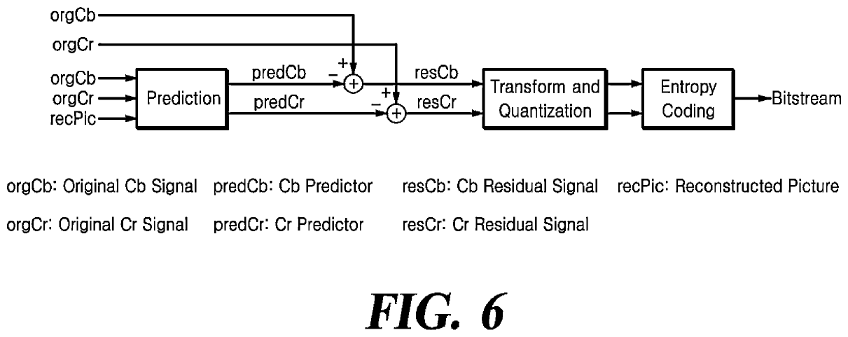

FIG. 6 is a diagram illustrating a process of encoding chroma components.

In the prior art, the video encoding device first generates predictors (predCb, predCr) of the chroma components by using various kinds of intra- or inter-prediction processes that are based on information from a previously reconstructed picture (recPic). The video encoding device subtracts the predictors from the original signals (orgCb, orgCr) to generate residual signals (resCb, resCr), which are then converted to signals in the frequency domain by using a conversion process. The video encoding device finally composes the bitstream by using a quantization process and an entropy encoding process.

Chroma channel encoding typically uses a method of applying a DCT-II transform to the residual signals of the Cb and Cr components sequentially in the horizontal and vertical directions, or a Transform Skip Mode method which skips the transform and turns directly to the quantization step. In conventional techniques, the video encoding device signals to the video decoding device the method to be applied to each component by using the transform_skip_flag[x][y][compID] as shown in Table 1.

TABLE 1
TU level

```
transform_unit( x0, y0, tbWidth, tbHeight, treeType, subTuIndex,
chType )
...
  if( tu_y_coded_flag[ x0 ][ y0 ] && treeType !=
  DUAL_TREE_CHROMA ) {
    if( sps_transform_skip_enabled_flag && !BdpcmFlag[ x0 ][ y0
    ][ 0 ] &&
        tbWidth <= MaxTsSize && tbHeight <= MaxTsSize &&
        ( IntraSubPartitionsSplitType = = ISP_NO_SPLIT ) &&
        !cu_sbt_flag )
      transform_skip_flag[ x0 ][ y0 ][ 0 ]
...
  if( tu_cb_coded_flag[ xC ][ yC ] && treeType !=
  DUAL_TREE_LUMA ) {
    if( sps_transform_skip_enabled_flag && !BdpcmFlag[ x0 ][ y0
    ][ 1 ] &&
        wC <= MaxTsSize && hC <= MaxTsSize && !cu_sbt_flag )
      transform_skip_flag[ xC ][ yC ][ 1 ]
    if( !transform_skip_flag[ xC ][ yC ][ 1 ] | |
    sh_ts_residual_coding_disabled_flag )
      residual_coding( xC, yC, Log2( wC ), Log2( hC ), 1 )
    else
      residual_ts_coding( xC, yC, Log2( wC ), Log2( hC ), 1 )
  }
  if( tu_cr_coded_flag[ xC ][ yC ] && treeType !=
  DUAL_TREE_LUMA &&
    !( tu_cb_coded_flag[ xC ][ yC ] &&
    tu_joint_cbcr_residual_flag[ xC ][ yC ] ) ) {
    if( sps_transform_skip_enabled_flag && !BdpcmFlag[ x0 ][ y0
    ][ 2 ] &&
        wC <= MaxTsSize && hC <= MaxTsSize && !cu_sbt_flag )
      transform_skip_flag[ xC ][ yC ][ 2 ]
...
```

Here, x, y are the coordinates of the top-left pixel of the current residual block for each channel. compID indicates the Y component if it is 0, the Cb component if compID is 1, and the Cr component if it is 2. If transform_skip_flag[x][y][compID] is 1, the Transform Skip Mode is applied, and if transform_skip_flag[x][y][compID] is 0, the DCT-II transform is applied to the residual signal in the horizontal and vertical directions. Hereafter, for descriptive convenience, transform_skip_flag[x][y][1] and transform_skip_flag[x][y][2], which are applied to the two-component signals in the chroma channel, respectively, are commonly referred to as transform_skip_flag. Additionally, to simplify the representation, omitted from transform_skip_flag[x][y][compID] is the x, y representation of the coordinates of the top-left pixel of the current residual block to leave transform_skip_flag[compID].

### II. Joint Coding for Chroma Residual (JCCR) Technique

The Joint Coding for Chroma Residual (JCCR) technique is to solve the problem of the conventional method of encoding the residual signals of Cb and Cr components respectively and improving the coding efficiency. Based on the fact that the residual signals of Cb and Cr are inversely correlated with each other, the JCCR technology combines the residual signals of the two components into one to generate and then encode a new residual signal. The video encoding device may signal tu_joint_cbcr_residual_flag per transform unit (TU), the basic unit of residual signal encoding, to the video decoding device to indicate whether to use JCCR technology in the chroma channel. If tu_joint_cbcr_residual_flag is 0, the JCCR technique is not used and the residual signal and transform_skip_flag are sent to the video decoding device for each of the Cb and Cr components as described above. This is referred to as the case where the JCCR mode is 0. If tu_joint_cbcr_residual_flag is 1, the JCCR technique is applied. Then, the residual signals of Cb and Cr may be combined into one, and the combined residual signal may be encoded and decoded.

The JCCR technique has a total of three modes (JCCR modes). Depending on the combination of coded block flags (CBFs) that indicate whether any of the conversion factor or coefficient levels of each component has a non-zero value, the three modes are classified as shown in Table 2. In other words, the JCCR modes may be classified according to three combinations of 0 and 1 except when the CBF value CBF_{cb} (=tu_cb_coded_flag) of the Cb component and the CBF value CBF_{cr} (=tu_cr_coded_flag) of the Cr component are both zero.

TABLE 2

| | CBF_{Cb} | CBF_{Cr} |
|---|---|---|
| JCCR mode | (tu_cb_coded_flag) | (tu_cr_coded_flag) |
| 1 | 1 | 0 |
| 2 | 1 | 1 |
| 3 | 0 | 1 |

After the JCCR mode is selected, the combined residual signal is encoded and decoded per mode as shown in Table 3.

TABLE 3

| JCCR | Coded | resJointC Calculation | Reconstruction of Cb and |
|---|---|---|---|
| mode | Channel | (Encoder) | Cr residuals (Decoder) |
| 1 | Cb | resJointC = | resCb = resJointC |
| | | (4 × resCb + 2 × cSign × | resCr = (cSign × |
| | | resCr)/5 | resJointC) >> 1 |
| 2 | Cb | resJointC = | resCb = resJointC |
| | | (resCb + cSign × resCr)/2 | resCr = cSign × resJointC |
| 3 | Cr | resJointC = | resCb = (cSign × |
| | | (4 · resCr + 2 × cSign × | resJointC) >> 1 |
| | | resCb)/5 | resCr = resJointC |

The video encoding device combines the residual signal resCb of the Cb component with the residual signal resCr of the Cr component by using a preset equation (resJointC Calculation in Table 3) for each JCCR mode to generate a new residual signal resJointC. The video encoding device then encodes and transmits the new residual signal resJointC to the video decoding device. It should be noted that the equations presented in resJointC Calculation in Table 3 represent three simple cases that may not be sufficient to model the various correlations present in the video.

The video decoding device receives the transmitted tu_cb_coded_flag and tu_cr_coded_flag values and determines a JCCR mode according to Table 2. Then, the video decoding device reconstructs the residual signals of the original Cb and Cr components from the transmitted resJointC according to the preset equation for each mode (Reconstruction of Cb and Cr residuals in Table 3). At this time, the video decoding device determines which channel of the Cb and Cr channels to immediately use the transmitted resJointC as the value of the Cb or Cr channel according to the JCCR mode. Hereinafter, the channel used immediately is called the coded channel, hereinafter referred to as the ‘representative channel’. According to Table 3, when the JCCR mode is 1 or 2, resJointC is used as the Cb channel (i.e., the coded channel becomes the Cb channel), and when the JCCR mode is 3, resJointC is used as the Cr channel (i.e., the coded channel becomes the Cr channel). In Table 3, the channel that uses the resJointC as received is labeled as the coded channel.

A limitation of prior art JCCR techniques is that the coded channel is always one of the Cb and Cr channels. As described above, this limitation is due to the prior art modeling the correlation by using the three simple models described in Table 3, even though there may be a wide variety of correlations between the Cb and Cr channels. To solve the prior art limitation of the representative channel to either Cb or Cr channels, the present disclosure provides a technique that uses a wider variety of new channels as representative channels.

Meanwhile, cSign included in the equation to derive resJointC is a sign value calculated as shown in Equation 1. The ph_joint_cbcr_sign_flag is transmitted on a per-picture basis, which distinguishes whether the signs of the residual signals of Cb and Cr are the same or have an inverse relationship when applying the JCCR technique. If ph_joint_cbcr_sign_flag is 1, cSign=−1 whereby the residual signal signs of Cb and Cr are in reverse, and if ph_joint_cbcr_sign_flag is 0, cSign=1 whereby the residual signal signs of Cb and Cr are the same.

$$cSign = ( 1 - 2 \times ph\_joint \_cbcr \_sign \_flag ) \qquad Equation 1$$

The three JCCR modes specifically behave as follows. The following describes the operation of the JCCR modes based on a cSign value of −1.

First, when the JCCR mode is 1, the relationship between the residual signals of the Cb and Cr components is modeled as such that the residual signal resCb of the Cb component is −2 times the residual signal resCr of the Cr component, as shown in Equation 2. The video encoding device generates a new residual signal resJointC according to Equation 3. The video encoding device then indicates in the transform_skip_flag[1] of the Cb component the resJointC and information on whether the transform skip mode is applied to the relevant residual signal according to Table 3, and transmits the resultant transform_skip_flag[1] to the video decoding device.

$$resCb = cSign \times 2 \times resCr \qquad Equation 2$$

$$resJointC = ( 4 \times resCb + cSign \times 2 \times resCr ) / 5 \qquad Equation 3$$

The video decoding device reconstructs the residual signals of the Cb and Cr components according to Equation 4 by using the transmitted resJointC. At this time, the relationship of Equation 2 may be derived by setting and organizing the resJointC set in Equation 3 and Equation 4 to an equation as shown in Equation 5.

$$resCb = resJointC \qquad Equation 4$$

$$resCr = ( cSign \times resJointC ) >> 1$$

$$( 4 \times resCb + cSign \times 2 \times resCr ) / 5 = resCb \to 4 \times resCb + cSign \times 2 \times resCr = 5 \times resCb \to resCb = cSign \times 2 \times resCr \qquad Equation 5$$

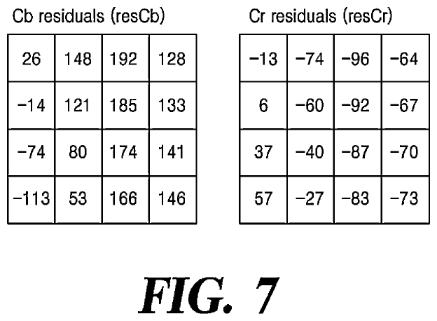

When the JCCR mode is 1, the residual signals of the Cb and Cr components for a 4×4 block may be represented as in the example of FIG. 7.

When the JCCR mode is 2, the relationship between the residual signals of the Cb and Cr components is modeled as such that the residual signal resCb of the Cb component is −1 times the residual signal resCr of the Cr component, as shown in Equation 6. The video encoding device generates a new residual signal resJointC according to Equation 7. Then, the video encoding device indicates in the transform_skip_flag[1] of the Cb component the resJointC and information on whether to apply the Transform Skip Mode to the relevant residual signal according to Table 3 and transmits the resultant transform_skip_flag[1] to the video decoding device.

$$resCb = cSign \times resCr \qquad Equation 6$$

$$resJointC = ( resCb + cSign resCr ) / 2 \qquad Equation 7$$

The video decoding device reconstructs the residual signals of the Cb and Cr components according to Equation 8 by using the transmitted resJointC. At this time, the relationship of Equation 6 may be derived by setting and organizing the resJointC set in Equation 7 and Equation 8 to an equation as shown in Equation 9.

$$resCb = resJointC \qquad Equation 8$$

$$resCr = cSign \times resJointC$$

$$( resCb + cSign \times resCr ) / 2 = resCb \to resCb + cSign \times resCr = 2 \times resCb \to = cSign \times resCr \qquad Equation 9$$

When the JCCR mode is 3, the relationship between the residual signals of the Cb and Cr components is modeled such that the residual signal resCr of the Cr component is −2 times the residual signal resCb of the Cb component, as shown in Equation 10. The video encoding device generates a new residual signal resJointC according to Equation 11. The video encoding device then indicates in the transform_skip_flag[2] of the Cr component the resJointC and information on whether to apply the transform skip mode to the relevant residual signal according to Table 3 and transmits the resultant transform_skip_flag[2] to the video decoding device.

$$resCr = cSign \times 2 \times resCb \qquad Equation 10$$

$$resJointC = ( 4 \times resCr + cSign \times 2 \times resCb ) / 5 \qquad Equation 11$$

The video decoding device reconstructs the residual signals of the Cb and Cr components according to Equation 12 by using the transmitted resJointC. At this time, the relationship of Equation 10 may be derived by setting and organizing the resJointC set in Equation 11 and Equation 12 to an equation as shown in Equation 13.

$$resCb = ( cSign \times resJointC ) >> 1 \qquad Equation 12$$

$$resCr = resJointC$$

$$( 4 \times resCr + cSign \times 2 \times resCb ) / 5 = resCr \to 4 \times resCr + cSign \times 2 \times resCb = 5 \times resCr \to resCr = cSign \times 2 \times resCb \qquad Equation 13$$

The problem with the above-described process of encoding and decoding chroma channel residual signals is that the JCCR technique ignores the various relationships between the Cb and Cr components. In other words, merely three highly simplified proportional relationships are modeled to combine the residual signals of the two components into one, and then encoding and decoding proceed. However, there are many more correlations between the Cb and Cr components than the three proportional relationships mentioned above. This phenomenon may be more pronounced when the chroma channel has a higher resolution, such as in 4:2:2 and 4:4:4 color formats. As a result, the usefulness of conventional JCCR techniques can be reduced, especially when the resolution of the chroma channels is high. These issues of conventional techniques can be solved according to the present disclosure by applying an adaptive chrominance space conversion (CSC) that reflects the different correlations between the two components Cb and Cr in the chroma channel. The signal in the chroma channel to which the chrominance space conversion according to the present disclosure is applicable may include a residual signal, a predictor, an original signal, and the like.

### III. Adaptive Chrominance Space Conversion

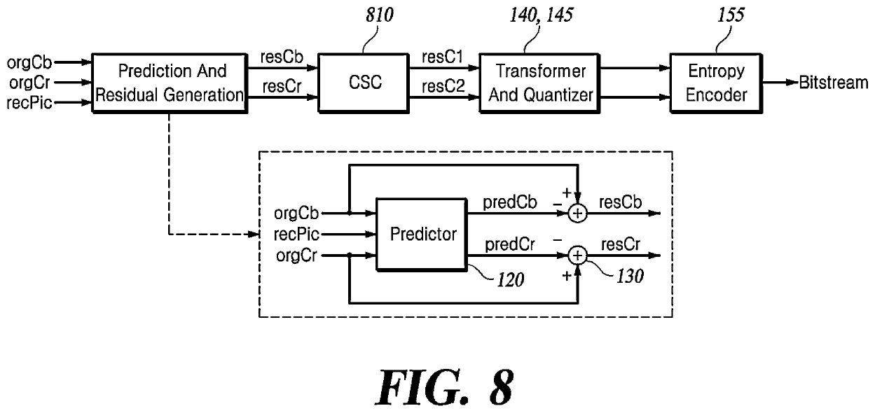

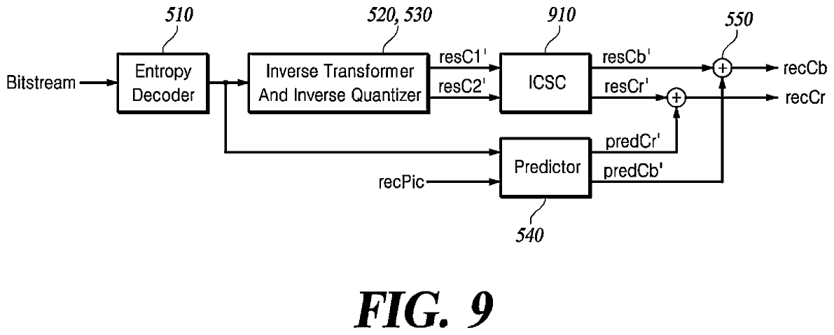

FIGS. 8 and 9 are diagrams illustrating the video encoding device applying chrominance space conversion and the video decoding device applying inverse chrominance space conversion, according to some embodiments of the present disclosure.

In the examples of FIGS. 8 and 9, a chrominance space conversion (CSC) 810 and an inverse chrominance space conversion (ICSC) 910 according to the present disclosure are applied to residual signals in a chroma channel.

The video encoding device applies the CSC 810 to the two-component residual signals resCb, resCr to generate new converted residual signals resC1, resC2, and applies thereto conversion, quantization, and entropy encoding for generating a compressed bitstream. To the received compressed bitstream, the video encoding device applies entropy decoding, inverse quantization, and inverse transform for reconstructing converted residual signals resC1′, resC2′. The video decoding device applies the ICSC 910 to the converted residual signals to reconstruct the residual signals resCb′, resCr′ of the two channels Cb and Cr. The video decoding device then adds the residual signals with the predictors predCb′, predCr′ generated by using the applicable prediction method and the previously reconstructed picture recPic to generate the final reconstructed signals recCb, recCr.

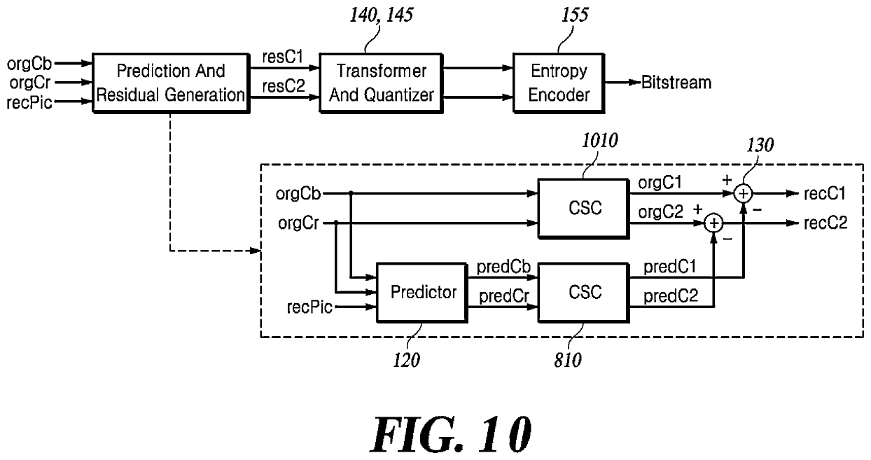

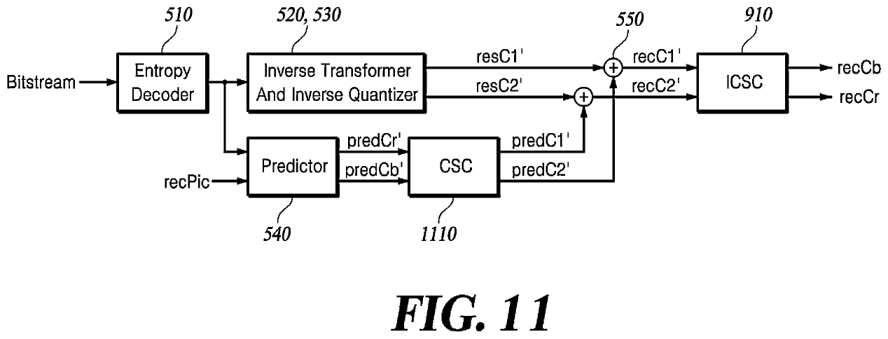

FIGS. 10 and 11 are diagrams illustrating the video encoding device applying chrominance space conversion and the video decoding device applying inverse chrominance space conversion, according to another embodiment of the present disclosure.

In the examples of FIGS. 10 and 11, the CSCs 810, 1010, 1110, and the ICSC 910 according to the present disclosure are applied to the predictors in the chroma channel.

The video encoding device applies the CSC 810 to the two-component Cb and Cr predictors predCb and predCr predicted by using information on the previously reconstructed picture recPic to generate new converted predictors predC1, predC2. Similarly, the CSC 1010 is applied to the original signals orgCb, orgCr to generate new converted original signals orgC1, orgC2. The video encoding device then subtracts the converted predictors from the converted original signals to generate residual signals resC and resC2 which are transformed, quantized, and entropy encoded to generate a compressed bitstream.

The video decoding device applies entropy decoding, inverse quantization, and inverse transform to the transmitted compressed bitstream to reconstruct new converted residual signals resC1′, resC2′. The video decoding device generates predictors predCb′, predCr′ according to the applicable prediction method, and applies CSC 1110 to the predictors to generate converted predictors predC1′, predC2′. The video decoding device then adds the converted residual signals resC1′, resC2′ to the converted predictors predC1′, predC2′ to reconstruct the converted reconstructed signals recC1′, recC2′. Finally, the video decoding device applies the ICSC 910 to the converted reconstructed signals recC1′, recC2′ to generate the reconstructed signals recCb, recCr.

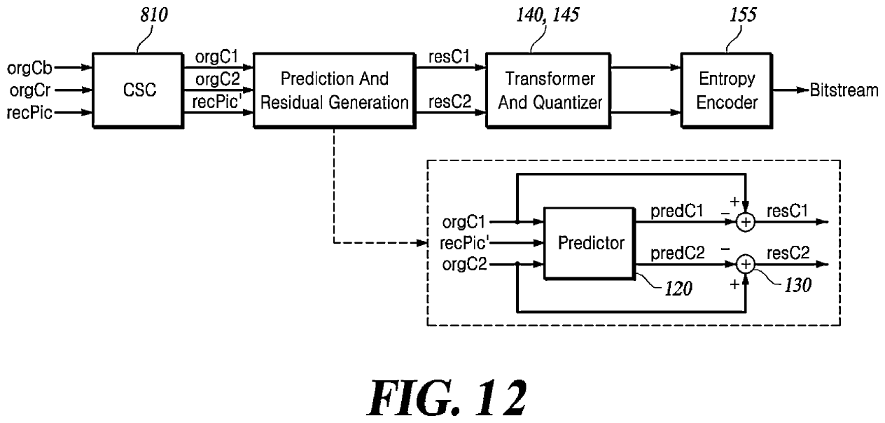

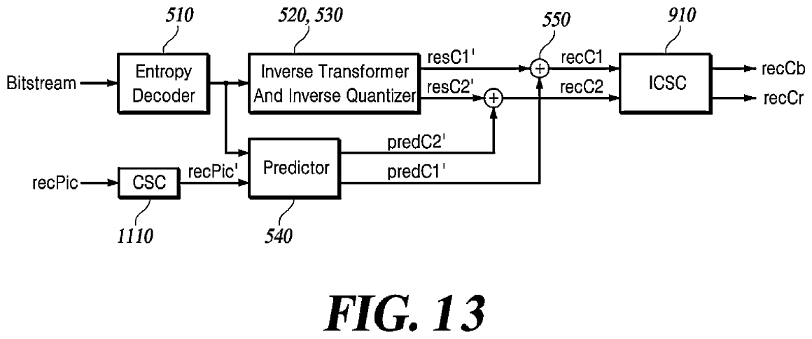

FIGS. 12 and 13 are diagrams illustrating the video encoding device applying chrominance space conversion and the video decoding device applying inverse chrominance space conversion, according to yet another embodiment of the present disclosure.

In the examples of FIGS. 12 and 13, the CSC 810 and the ICSC 910 according to the present disclosure are applied to the original signals in the chroma channel.

The video encoding device applies the CSC 810 to the original signals orgCb, orgCr, and the previously reconstructed picture recPic to generate new converted original signals orgC1, orgC2, and the reconstructed converted picture recPic′, and performs a prediction method, such as intra prediction or inter prediction, on the converted original signals and the reconstructed converted picture to generate converted predictors predC1, predC2. The video encoding device then subtracts the predictors from the converted original signals orgC1, orgC2 to generate converted residual signals resC1 and resC2 which are transformed, quantized, and entropy encoded to generate a compressed bitstream.

The video decoding device applies entropy decoding, inverse quantization, and inverse transform to the transmitted compressed bitstream to reconstruct the converted residual signals resC1′, resC2′. The video decoding device generates the converted predictors predC1′, predC2′ according to the applicable prediction method and the recPic′ information from applying the CSC 1110 to the previously reconstructed picture recPic. The video decoding device then adds the converted residual signals resC1′, resC2′ to the converted predictors predC1′, predC2′ to reconstruct the converted reconstructed signals recC1, recC2. Finally, the video decoding device applies the ICSC 910 to the converted reconstructed signals recC1, recC2 to generate the reconstructed signals recCb, recCr.

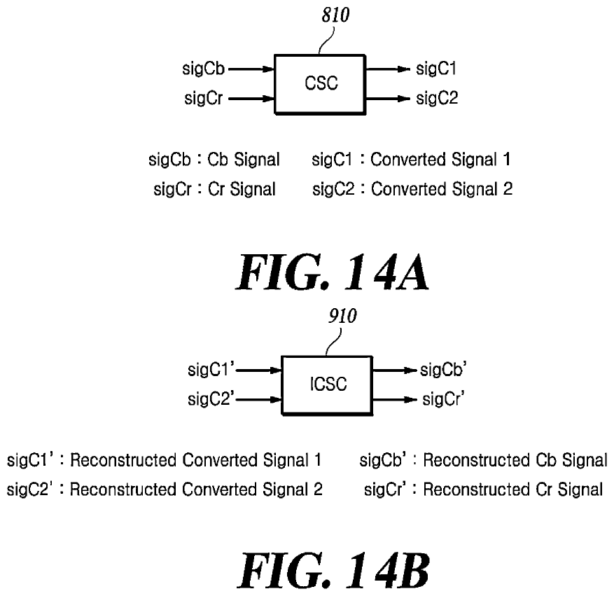

FIGS. 14A and 14B are diagrams illustrating a chrominance space conversion (CSC) and an inverse chrominance space conversion (ICSC), according to some embodiments of the present disclosure.

The CSC 810 generates two converted signals from the two component signals in the chroma channel, as shown in the example of FIG. 14A. In this case, the chrominance space conversion may be implemented in various ways depending on how the Cb and Cr two-component signals are combined to generate the two converted signals. In terms of optimizing coding efficiency, the video encoding device selects one of the various chrominance space conversion methods and signals the two converted signals and the syntax information related to the selected method through the bitstream to the video decoding device. The video decoding device decodes that chrominance space conversion method from the bitstream. Further, as shown in the example of FIG. 14B, the ICSC 910 generates the original Cb and Cr signals from the reconstructed converted signals by using inverse chrominance space conversion, which is the reverse process of the chrominance space conversion operation used by the video encoding device. Specific implementations are described below.

### <Implementation 1> Combining Cb and Cr Component Signals to Generate Two Converted Signals

This implementation is a chrominance space conversion method that combines Cb and Cr component signals in a chroma channel according to a specific equation for generating two converted signals.

The video encoding device combines the Cb, Cr component signals, sigCb and sigCr, according to the matrix expression of Equation 14 or its equivalent Equation 15, to generate and then encode the converted signals, sigC1 and sigC2.

$$[ \begin{matrix}s i g C 1 \\ sigC 2\end{matrix} ] = A [ \begin{matrix}s i g C b \\ sigCr\end{matrix} ] where \{ A = [ \begin{matrix}a & b \\ c & d\end{matrix} ] \} \qquad Equation 14$$

$$sigC 1 = a \cdot sigCb + b \cdot sigCr \qquad Equation 15$$

$$sigC 2 = c \cdot sigCb + d \cdot sigCr$$

Here, a combination matrix A is a 2×2 matrix which may be determined in various forms depending on the application. The video encoding device may combine the Cb and Cr component signals based on combination matrix A to generate the two converted signals.

The video decoding device combines the reconstructed converted signals sigC1′ and sigC2′ according to the matrix expression of Equation 16 or its equivalent Equation 17, and generates and then decodes reconstructed Cb, Cr two-component signals sigCb′ and sigCr′.

$$[ \begin{matrix}{sigCb}^{′} \\ {sigCr}^{′}\end{matrix} ] = {A}^{- 1} [ \begin{matrix}sigC {1}^{′} \\ sigC {2}^{′}\end{matrix} ] where \qquad Equation 16$$

$$\{ {A}^{- 1} = [ \begin{matrix}g & h \\ i & j\end{matrix} ] = \frac{1}{a d - b c} [ \begin{matrix}d & - b \\ - c & a\end{matrix} ] \}$$

$${sigCb}^{′} = g \cdot sigC {1}^{′} + h \cdot sigC {2}^{′} \qquad Equation 17$$

$${sigCr}^{′} = i \cdot sigC {1}^{′} + j \cdot sigC {2}^{′}$$

Here, an inverse combination matrix A⁻¹ is the inverse matrix of the 2×2 matrix A used in the chrominance space conversion process by the video encoding device. Since various chrominance space conversion methods may exist depending on the value of combination matrix A, the video encoding device may signal to the video decoding device the selected chrominance space conversion method to be applied to the Cb and Cr component signals. Depending on the embodiment, the video encoding device may use a method of signaling values of combination matrix A or a method of signaling an index of a preset combination matrix A. In this case, the video decoding device includes calculating the inverse matrix of A⁻¹ corresponding to the signaled combination matrix A. In another embodiment, the video encoding device may use a method of signaling values of A⁻¹, or a method of signaling an index of a preset A⁻¹. The video encoding device may signal this information to the video decoding device on a block-by-block basis. Alternatively, instead of transmitting the information block by block, the information transmitted once may be shared by a plurality of blocks.

In this implementation, the method of signaling the combination matrix A, or the method of signaling the inverse combination matrix A⁻¹, relies on one of the following schemes.

First, when an index of the preset combination matrix A is signaled, the video encoding device may separate the preset combination matrix A by indexes by using a new syntax named conversion_mode_index[x][y], as shown in Table 4. Then, the video encoding device may signal the index of combination matrix A to the video decoding device for each chroma block. The video decoding device may use the transmitted index to obtain the values of combination matrix A from the preset list as shown in Table 4.

TABLE 4

| conversion_mode_index | A | A⁻¹ |
|---|---|---|
| 0 | $[ \begin{matrix}1 & 1 \\ 1 & - 1\end{matrix} ]$ | $[ \begin{matrix}0.5 & 0.5 \\ 0.5 & - 0.5\end{matrix} ]$ |
| 1 | $[ \begin{matrix}2 & 1 \\ 1 & - 2\end{matrix} ]$ | $[ \begin{matrix}0.4 & 0.2 \\ 0.2 & - 0.4\end{matrix} ]$ |
| 2 | $[ \begin{matrix}1 & 2 \\ - 2 & 1\end{matrix} ]$ | $[ \begin{matrix}- 0.2 & - 0.4 \\ 0.4 & - 0.2\end{matrix} ]$ |

Here, x, y are the coordinates of the top-left pixel of the current residual block that is subjected to this syntax. Hereinafter, conversion_mode_index[x][y] is referred to as conversion_mode_index with its coordinate values omitted.

Second, when the values of the combination matrix A are directly signaled, the video encoding device utilizes a new array of syntax cbcr_conversion_matrix[x][y][numComp]. Here, x, y are the coordinates of the top-left pixel of the current residual block that is subjected to the corresponding syntax. numComp indicates the number of components in the combination matrix. In one preferred implementation, numComp may have a value of 4. Further, the video encoding device may assign to cbcr_conversion_matrix[x][y][4] the values of the four components of combination matrix A in the form of an array such as {a,b,c,d}, and the assigned component values may be signaled to the video decoding device for each chroma block. Hereinafter, cbcr_conversion_matrix[x][y][numComp] is referred to as cbcr_conversion_matrix[numComp] with its x, y coordinate values omitted.

Third, when the index of preset A⁻¹ is signaled, the video encoding device identifies the preset inverse combination matrix A⁻¹ by the index, using the conversion_mode_index as shown in Table 4. The video encoding device may then signal the index of inverse combination matrix A⁻¹ to the video decoding device. The video decoding device may use the transmitted index to obtain the values of inverse combination matrix A⁻¹ from the preset list as shown in Table 4.

Fourth, when the values of inverse combination matrix A⁻¹ are directly signaled, the video encoding device utilizes cbcr_conversion_matrix[numComp]. Here, numComp may have a value of 4. Further, the video encoding device may assign to cbcr_conversion_matrix[4] the values of the four components of inverse combination matrix A⁻¹ in the form of an array, such as {g, h, i, j}, to signal the assigned component values to the video decoding device.

### <Implementation 2> Combining the Cb, Cr Component Signals and Adding an Offset to Generate the Two Converted Signals

This implementation is a chrominance space conversion method that combines the component signals of Cb and Cr in the chroma channel according to a specific equation and adds an offset, which is a DC component, to generate two converted signals.

The video encoding device combines the two component signals of Cb and Cr, sigCb and sigCr, according to the matrix expression of Equation 18 or its equivalent matrix expression of Equation 19. The video encoding device then adds the offset to generate the converted signals, sigC1 and sigC2, which may be used in the next encoding step.

$$[ \begin{matrix}s i g C 1 \\ sigC 2\end{matrix} ] = A [ \begin{matrix}s i g C b \\ sigCr\end{matrix} ] + B where \{ A = [ \begin{matrix}a & b \\ c & d\end{matrix} ] , B = [ \begin{matrix}e \\ f\end{matrix} ] \} \qquad Equation 18$$

$$sigC 1 = a \cdot sigCb + b \cdot sigCr + e \qquad Equation 19$$

$$sigC 2 = c \cdot sigCb + d \cdot sigCr + f$$

Here, combination matrix A is any 2×2 matrix, which may be in the form exemplified in Table 5. An offset matrix B may be any 2×1 matrix and may be in the form exemplified in Table 5. Depending on the embodiment, matrices A and B may have various forms, including but not limited to Table 5. The video encoding device may use the matrices A and B to generate the two converted signals by combining the Cb and Cr component signals and adding the offset.

TABLE 5

| | |
|---|---|
| Combination Matrix A | $[ \begin{matrix}1 & 1 \\ 1 & - 1\end{matrix} ] , [ \begin{matrix}2 & 1 \\ 1 & - 2\end{matrix} ] , [ \begin{matrix}1 & 2 \\ - 2 & 1\end{matrix} ]$ |
| Offset Matrix B | $[ \begin{matrix}23 \\ - 10\end{matrix} ] , [ \begin{matrix}50 \\ 11\end{matrix} ] , [ \begin{matrix}20 \\ 20\end{matrix} ]$ |

The video decoding device may combine the reconstructed converted signals sigC1′ and sigC2′ according to the matrix expression of Equation 20 or its equivalent Equation 21 to generate reconstructed Cb, Cr two-component signals sigCb′ and sigCr′, which may then be used in the next decoding step.

$$[ \begin{matrix}{sigCb}^{′} \\ {sigCr}^{′}\end{matrix} ] = {A}^{- 1} ( [ \begin{matrix}sigC {1}^{′} \\ sigC {2}^{′}\end{matrix} ] - B ) \qquad Equation 20$$

$$where \{ {A}^{- 1} = [ \begin{matrix}g & h \\ i & j\end{matrix} ] = \frac{1}{a d - b c} [ \begin{matrix}d & - b \\ - c & a\end{matrix} ] , B = [ \begin{matrix}e \\ f\end{matrix} ] \}$$

$${SigCb}^{′} = g \cdot sigC {1}^{′} + h \cdot sigC {2}^{′} - e \cdot g - f \cdot h \qquad Equation 21$$

$${sigCr}^{′} = i \cdot sigC {1}^{′} + j \cdot sigC {2}^{′} - e \cdot i - f \cdot j$$

Here, inverse combination matrix A⁻¹ is the inverse matrix of the 2×2 combination matrix A used in the chrominance space conversion process by the video encoding device, and offset matrix B is the matrix used in the chrominance space conversion process. Since various chrominance space conversion methods may exist depending on the values of combination matrix A and offset matrix B, the video encoding device may signal to the video decoding device the optimal chrominance space conversion method applied to the signals of the two components Cb and Cr.

Depending on the embodiments, the video encoding device may use a method of signaling values of combination matrix A and offset matrix B, or a method of signaling an index of each preset matrix. In this case, the video decoding device may include the process of calculating the inverse matrix A⁻¹ corresponding to the signaled combination matrix A. As another example, the video encoding device may use a method of signaling the values of inverse combination matrix A⁻¹ and offset matrix B, or a method of signaling an index of each preset matrix. The video encoding device may signal this information to the video decoding device on a block-by-block basis. Alternatively, instead of transmitting block by block, the information once transmitted may be shared by a plurality of blocks.

In this implementation, the method of signaling the combination matrix A and the offset matrix B, or the method of signaling the inverse combination matrix A⁻¹ and offset matrix B, relies on one of the following schemes.

First, when the indices of the preset combination matrix A and offset matrix B are signaled, the video encoding device may separate the preset combination matrix A and offset matrix B by an index by using the conversion_mode_index defined in Implementation 1, as shown in Table 6. The video encoding device may then signal the above-described index to the video decoding device for each chroma block. The video decoding device may use the transmitted index to obtain the values of combination matrix A and offset matrix B from the preset list as shown in Table 6.

TABLE 6

| conversion_mode_index | A | B |
|---|---|---|
| 0 | $[ \begin{matrix}1 & 1 \\ 1 & - 1\end{matrix} ]$ | $[ \begin{matrix}23 \\ - 10\end{matrix} ]$ |
| 1 | $[ \begin{matrix}2 & 1 \\ 1 & - 2\end{matrix} ]$ | $[ \begin{matrix}50 \\ 11\end{matrix} ]$ |
| 2 | $[ \begin{matrix}1 & 2 \\ - 2 & 1\end{matrix} ]$ | $[ \begin{matrix}20 \\ 20\end{matrix} ]$ |

Second, when the values of combination matrix A are directly signaled and the index of the preset offset matrix B is signaled, the video encoding device may utilize the cbcr_conversion_matrix[numComp] defined in Implementation 1. For example, the video encoding device may set numComp to 4 and may signal to the video decoding device by assigning to cbcr_conversion_matrix[4] the values of the four components of combination matrix A in the form of an array such as {a, b, c, d}. Further, the video encoding device may signal the index of the preset offset matrix B to the video decoding device for each chroma block by using the conversion_mode_index as shown in Table 6.

Third, when the index of the preset combination matrix A is signaled and the values of offset matrix B are directly signaled, the video encoding device may signal the index of the preset combination matrix A to the video decoding device by using a conversion_mode_index as exemplified in Table 6. Further, the video encoding device may signal the video decoding device by setting numComp to 2 and assigning to cbcr_conversion_matrix[2] the values of the two components of offset matrix B in the form of an array such as {e, f}.

Fourth, when the values of combination matrix A and offset matrix B are directly signaled, the video encoding device may set numComp to 6 and assign to cbcr_conversion_matrix[6] the four component values of combination matrix A and the values of offset matrix B, i,e., a total of six component values, in an array such as {a, b, c, d, e, f}, to signal the assigned component values to the video decoding device.

Fifth, when the index of the preset inverse combination matrix A⁻¹ and offset matrix B is signaled, the video encoding device may separate the preset inverse combination matrix A⁻¹ and offset matrix B by the index by using the conversion_mode_index defined in Implementation 1, as shown in Table 7. The video encoding device may then signal the above-described index to the video decoding device for each chroma block. The video decoding device may use the transmitted index to obtain the values of inverse combination matrix A⁻¹ and offset matrix B from the preset list as shown in Table 7.

TABLE 7

| conversion_mode_index | A⁻¹ | B |
|---|---|---|
| 0 | $[ \begin{matrix}0.5 & 0.5 \\ 0.5 & - 0.5\end{matrix} ]$ | $[ \begin{matrix}23 \\ - 10\end{matrix} ]$ |
| 1 | $[ \begin{matrix}0.4 & 0.2 \\ 0.2 & - 0.4\end{matrix} ]$ | $[ \begin{matrix}50 \\ 11\end{matrix} ]$ |
| 2 | $[ \begin{matrix}- 0.2 & - 0.4 \\ 0.4 & - 0.2\end{matrix} ]$ | $[ \begin{matrix}20 \\ 20\end{matrix} ]$ |

Sixth, when the values of inverse combination matrix A⁻¹ are directly signaled and the index of the preset offset matrix B is signaled, the video encoding device may utilize the cbcr_conversion_matrix[numComp] defined in Implementation 1. For example, the video encoding device may set numComp to 4 and may assign the values of the four components of inverse combination matrix A⁻¹ to cbcr_conversion_matrix[4] in the form of an array, such as {g, h, i, j}, to signal the assigned component values to the video decoding device. Further, the video encoding device may signal the index of the preset offset matrix B to the video decoding device for each chroma block by using the conversion_mode_index as shown in Table 6.

Seventh, when the index of the preset inverse combination matrix A⁻¹ is signaled and the values of offset matrix B are directly signaled, the video encoding device may signal the index of the preset inverse combination matrix A⁻¹ to the video decoding device by using a conversion_mode_index as exemplified in Table 6. Further, the video encoding device may signal the video decoding device by setting numComp to 2 and assigning to cbcr_conversion_matrix[2] the values of the two components of offset matrix B in the form of an array such as {e, f}.

Eighth, when the values of inverse combination matrix A⁻¹ and offset matrix B are directly signaled, the video encoding device may signal to the video decoding device by setting numComp to 6 and assigning to cbcr_conversion_matrix[6] the four component values of inverse combination matrix A⁻¹ and the values of offset matrix B, i.e., a total of six component values, in an array such as {g, h, i, j, e, f}.

<Implementation 3> Combining the Cb and Cr Component Signals to Generate Two Converted Signals, with One Converted Signal Set to be One of the Cb and Cr Signals

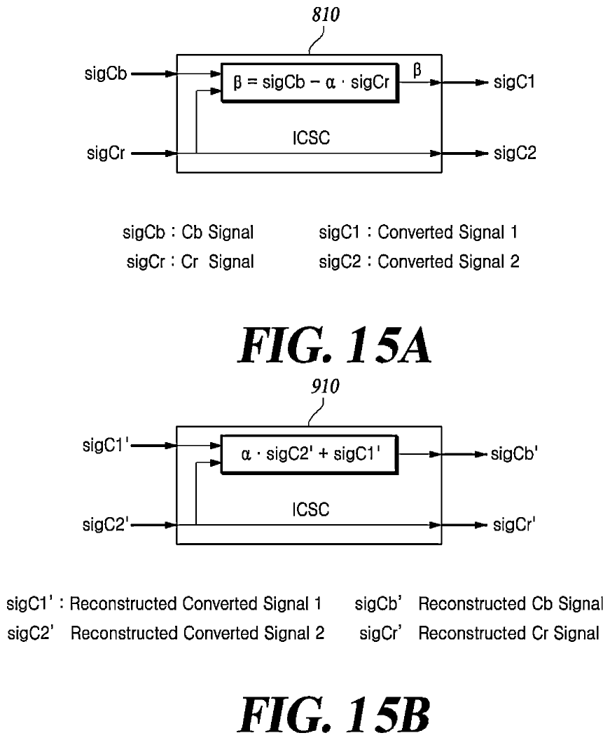

FIGS. 15A and 15B are diagrams illustrating a CSC and an ICSC, in accordance with other embodiments of the present disclosure.

As illustrated in FIGS. 15A and 15B, this implementation is a chrominance space conversion method that combines two component signals in the chroma channel, Cb and Cr, to generate two converted signals with one converted signal set to be one of the Cb and Cr signals. Hereinafter, for descriptive convenience, the case of using the Cr signal as the converted signal is described, but the same operation is feasible with the converted signal changed to Cb.

The linear relationship between the Cb and Cr components based on the Cb component may be expressed as shown in Equation 22.

$$s i g C b = α \cdot sigCr + β \qquad Equation 22$$

Here, α is a coefficient that is multiplied by the Cr component signal, which may be various values such as ±1, ±2, ±½, and the like. β is a constant and may be derived according to Equation 23, which is a variation of Equation 22.

$$β = s i g C b - α \cdot sigCr \qquad Equation 23$$

The video encoding device may set sigCr immediately to one converted signal, sigC2, as shown in FIG. 15A and Equation 24, and set the β derived according to Equation 23 to the remaining converted signal, sigC1, to generate a total of two converted signals, which may then be used in the next encoding step. In other words, the video encoding device may combine the Cb and Cr component signals to generate two converted signals with one converted signal set to be one of the Cb and Cr components.

$$s i g C 1 = β , s i g C 2 = s i g C r \qquad Equation 24$$

The video decoding device may combine the reconstructed converted signals sigC1′ and sigC2′ according to Equation 25 to generate reconstructed Cb, Cr two-component signals sigCb′ and sigCr′, as shown in the example of FIG. 15B, and use the reconstructed Cb, Cr two-component signals in the next decoding step.

$${sigCr}^{′} = sigC {2}^{′} \qquad Equation 25$$

$${sigCb}^{′} = α \cdot sigC {2}^{′} + sigC {1}^{′}$$

Since various chrominance space conversion methods may exist depending on the value of the coefficient α, the video encoding device may signal to the video decoding device the optimal chrominance space conversion method applied to the signals of the two components Cb and Cr. Depending on the embodiment, the video encoding device may use a method of directly signaling an α value or a method of signaling an index of a preset α value. The video encoding device may signal such information to the video decoding device on a block-by-block basis. Alternatively, instead of transmitting the information block by block, the information transmitted once may be shared by a plurality of blocks.

In this implementation, signaling the coefficient α relies on one of the following schemes.

First, when an index of the value of the preset coefficient α is signaled, the video encoding device separates the value of the preset coefficient α by an index by using the conversion_mode_index defined in Implementation 1, as shown in Table 8. The video encoding device may then signal the above-described index to the video decoding device for each chroma block.

TABLE 8

| conversion_mode_index | α |
|---|---|
| 0 | 1 |
| 1 | 2 |
| 2 | ½ |

Second, when the value of the coefficient α is directly signaled, the video encoding device utilizes a new syntax, cbcr_conversion_coefficient[x][y]. Here, x,y are the top-left pixel coordinates of the current residual block that is subjected to the new syntax. Hereinafter, cbcr_conversion_coefficient[x][y] is referred to as cbcr_conversion_coefficient with the coordinate values omitted. The video encoding device may assign a value of a coefficient α to the cbcr_conversion_coefficient and may signal the assigned value to the video decoding device for each chroma block.

### <Implementation 4> Signaling of a Syntax Related to the Chrominance Space Conversion Method

This implementation is a method of signaling syntax information related to the chrominance space conversion method according to any of Implementation 1 to Implementation 3.

The video decoding device receives the two converted signals (sigC1′, sigC2′) transmitted, is signaled with the type of chrominance space conversion method applied to the two converted signals and the accompanied additional syntax, and then reconstructs the original Cb, Cr component signals by performing an inverse chrominance space conversion method, which is the inverse operation of the chrominance space conversion. As described above, the Cb, Cr component signals may be residual signals, predicted signals, or original signals.

<Implementation 4-1> when the Cb, Cr Component Signals are Residual Signals

When the Cb and Cr component signals are residual signals, the video encoding device signals, for both component signals, a CBF value indicative of whether both component signals have a non-zero coefficient upon conversion to the frequency domain, and a conversion method for each component (i.e., whether the Transform Skip Mode or DCT-II transform is applied). Additionally, the video encoding device may signal syntax information related to the chrominance space conversion method of each implementation as Implementations 1 to 3 are applied. The chrominance space conversion method of Implementations 1 to 3 may be applied in four different ways, as follows.

### <Implementation 4-1-1> Applying the Chrominance Space Conversion Methods of Implementations 1 Through 3 Unconditionally.

In this implementation, the video decoding device may unconditionally apply the chrominance space conversion methods of Implementations 1 to 3 to replace the conventional method. Here, the conventional method refers to a method of decoding the residual signals of the Cb and Cr components, respectively, or a method of decoding by applying a JCCR technique. As an example, the syntax of the signals associated with the chrominance space conversion method may be organized as shown in Table 9 at the TU level. Hereinafter, the syntax is presented at the TU level unless otherwise noted.

TABLE 9
TU level

```
transform_unit( x0, y0, tbWidth, tbHeight, treeType, subTuIndex,
chType )
...
if( sps_joint_cbcr_enabled_flag && ( ( CuPredMode[ chType ][
x0 ][ y0 ]
  = = MODE_INTRA
      && ( tu_cb_coded_flag[ xC ][ yC ] | |
  tu_cr_coded_flag[ xC ][ yC ] ) ) | |
      ( tu_cb_coded_flag[ xC ][ yC ] && tu_cr_coded_flag[
      xC ][ yC ]
  ) ) &&
  chromaAvailable )
    tu_joint_cbcr_residual_flag[ xC ][ yC ]
  conversion_mode_index[ xC ][ yC ]
...
}
```

Here, chromaAvailable is 1 to indicate that the current residual block is a block in the chroma channel that is available for conversion, and 0 to indicate that other blocks are available for conversion.

According to Table 9, when the chrominance space conversion method of Implementations 1 through 3 is applied unconditionally, JCCR is not applied, which deletes the condition that checks whether the existing JCCR is applied and, accordingly, the tu_joint_cbcr_residual_flag that signals whether the JCCR is applied. In addition, conversion_mode_index, an index to distinguish between different chrominance space conversion methods within Implementations (1, 2, 3), is added to the existing flag location. The syntax added may also vary depending on the specific operating manner of each implementation. For Implementation 1 or 2, conversion_mode_index in Table 9 may be replaced by cbcr_conversion_matrix[numComp]. For Implementation 3, the conversion_mode_index in Table 9 may be replaced by cbcr_conversion_coefficient.

When the chrominance space conversion method of Implementations 1 to 3 is applied unconditionally, the CBF values for the original Cb and Cr residual signals in the prior art, and the syntax elements indicating whether or not the Transform Skip Mode is applied, are replaced with syntaxes for the two converted signals with chrominance space conversion applied.

As another example, the syntax of the signals associated with the chrominance space conversion method may be organized as shown in Table 10.

```
TABLE 10
transform_unit( x0, y0, tbWidth, tbHeight, treeType, subTuIndex,
chType )
...
tu_cb_coded_flag[ xC ][ yC ]
tu_cr_coded_flag[ xC ][ yC ]
if(tu_cb_coded_flag[ xC ][ yC ] | | tu_cr_coded_flag[ xC ][ yC ]){
...
if( sps_joint_cbcr_enabled_flag && ( ( CuPredMode[ chType ][
x0 ][ y0 ] = = MODE_INTRA
      && ( tu_cb_coded_flag[ xC ][ yC ] | |
tu_cr_coded_flag[ xC ][ yC ] ) ) | |
      ( tu_cb_coded_flag[ xC ][ yC ] && tu_cr_coded_flag[ xC ][
yC ] ) ) &&
      chromaAvailable )
    tu_joint_cbcr_residual_flag[ xC ][ yC ]
    tu_c1_coded_flag[ xC ][ yC ]
    tu_c2_coded_flag[ xC ][ yC ]
  conversion_mode_index[ xC ][ yC ]
...
}
...
}
```

Here, chromaAvailable is equal to 1, indicating that the current residual block is a block in the chroma channel that may be converted, and 0, indicating other blocks available for conversion.

According to Table 10, if the CBFs of the Cb and Cr residual signals are both zero, it is assumed that the chrominance space conversion method does not need to be performed and no associated syntax is signaled. If at least one of the CBFs of the Cb and Cr residual signals is non-zero and the chrominance space conversion method of Implementations 1 to 3 is unconditionally applied, the JCCR is not applied, which deletes the condition to check whether the existing JCCR is applied and the tu_joint_cbcr_residual_flag to signal whether the JCCR is applied accordingly. In addition, tu_c1_coded_flag[xC][yC] and tu_c2_coded_flag[xC][yC], the CBF values of the two converted signals, are added to the existing flag positions. Hereinafter, for descriptive convenience, the coordinates of the top-left pixel of the current residual block, xC, yC, are omitted and expressed as tu_c1_coded_flag and tu_c2_coded_flag.

In addition, conversion_mode_index, an index that distinguishes between different chrominance space conversion methods within each implementation, is added to the existing flag locations. The syntax added may also vary depending on the specific operating manner of each implementation. For Implementation 1 or 2, conversion_mode_index in Table 10 may be replaced by cbcr_conversion_matrix[numComp]. For Implementation 3, the conversion_mode_index in Table 10 may be replaced by cbcr_conversion_coefficient.

In contrast to Table 9, the syntax may be configured in a new way that does not follow the syntax composition of the existing VVC technology. In the VVC's syntax configuration, the syntax is signaled by the CBF values of the Cb and Cr components, the tu_joint_cbcr_residual_flag, and the transform_skip_flag of the Cb and Cr components in this sequence, as shown in Table 11.

```
TABLE 11
transform_unit( x0, y0, tbWidth, tbHeight, treeType, subTuIndex,
chType )
...
tu_cb_coded_flag[ xC ][ yC ]
tu_cr_coded_flag[ xC ][ yC ]
...
if( sps_joint_cbcr_enabled_flag && ( ( CuPredMode[ chType ][ x0 ][
    y0 ] = = MODE_INTRA &&
    ( tu_cb_coded_flag[ xC ][ yC ] | | tu_cr_coded_flag[ xC ][
          yC ] ) ) | | ( tu_cb_coded_flag[ xC ][ yC ] &&
    tu_cr_coded_flag[ xC ][ yC ] ) ) && chromaAvailable )
      tu_joint_cbcr_residual_flag[ xC ][ yC ]
...
  if( tu_cb_coded_flag[ xC ][ yC ] && treeType !=
  DUAL_TREE_LUMA )
      if( sps_transform_skip_enabled_flag && !BdpcmFlag[ x0 ][
        y0 ][ 1 ] && wC <= MaxTsSize && hC <= MaxTsSize &&
        !cu_sbt_flag )
        transform_skip_flag[ xC ][ yC ][ 1 ]
...
if( tu_cr_coded_flag[ xC ][ yC ] && treeType !=
DUAL_TREE_LUMA
    if( sps_transform_skip_enabled_flag && !BdpcmFlag[ x0 ][ y0 ][
      2 ] && wC <= MaxTsSize && hC <= MaxTsSize &&
      !cu_sbt_flag )
        transform_skip_flag[ xC ][ yC ][ 2 ]
...
```

This is because when tu_joint_cbcr_residual_flag is true and the JCCR technique is applied, the transform_skip_flags of the remaining components other than the reference component responsible for sending the transform_skip_flag for the combined residual signal are not signaled. Therefore, tu_joint_cbcr_residual_flag is signaled before the transform_skip_flag. However, if the chrominance space conversion method of Implementations 1 to 3 is applied unconditionally according to the new syntax composition, the transform_skip_flag to be applied for both converted signals needs to be signaled. Unlike when the JCCR technique is applied, the syntax that distinguishes the chrominance space conversion method does not need to be signaled before the transform_skip_flag. Therefore, as shown in Table 12, after the CBF values for the two converted signals are signaled, the transform_skip_flag for each signal is signaled.

```
TABLE 12
transform_unit( x0, y0, tbWidth, tbHeight, treeType, subTuIndex,
chType )
...
  if( tu_cb_coded_flag[ xC ][ yC ] && treeType !=
  DUAL_TREE_LUMA )
    if( sps_transform_skip_enabled_flag && !BdpcmFlag[ x0 ][ y0 ][
        1 ] && wC <= MaxTsSize && hC <= MaxTsSize &&
        !cu_sbt_flag )
          transform_skip_flag[ xC ][ yC ][ 1 ]
...
  if( tu_cr_coded_flag[ xC ][ yC ] && treeType !=
  DUAL_TREE_LUMA )
    if( sps_transform_skip_enabled_flag && !BdpcmFlag[ x0 ][ y0 ][
        2 ] && wC <= MaxTsSize && hC <= MaxTsSize &&
        !cu_sbt_flag )
          transform_skip_flag[ xC ][ yC ][ 2 ]
...
    if(chromaAvailable)
      conversion_mode_index[ xC ][ yC ]
...
```

In this case, the syntax components that distinguish the CBF values for the original Cb and Cr residual signals and whether or not the Transform Skip Mode is applied in the prior art are replaced with syntaxes for the two converted signals according to the chrominance space conversion. Then, an index, conversion_mode_index, is added to distinguish between different chrominance space conversion methods within each implementation.

The syntaxes added may also vary depending on the specific operating manner of each implementation. For Implementation 1 or 2, conversion_mode_index in Table 12 may be replaced by cbcr_conversion_matrix[numComp]. For Implementation 3, the conversion_mode_index in Table 12 may be replaced by cbcr_conversion_coefficient.

As another example, a syntax of signals associated with a chrominance space conversion method may be organized as shown in Table 13.

```
TABLE 13
transform_unit( x0, y0, tbWidth, tbHeight, treeType, subTuIndex,
chType )
...
tu_cb_coded_flag[ xC ][ yC ]
tu_cr_coded_flag[ xC ][ yC ]
if(tu_cb_coded_flag[ xC ][ yC ] | | tu_cr_coded_flag[ xC ][ yC ]){
  if( tu_c1_coded_flag[ xC ][ yC ] && treeType !=
  DUAL_TREE_LUMA )
    if( sps_transform_skip_enabled_flag && !BdpcmFlag[ x0 ][ y0 ][
          1 ] && wC <= MaxTsSize && hC <= MaxTsSize &&
          !cu_sbt_flag )
          transform_skip_flag[ xC ][ yC ][ 1 ]
...
  if( tu_c2_coded_flag[ xC ][ yC ] && treeType !=
  DUAL_TREE_LUMA )
        if( sps_transform_skip_enabled_flag && !BdpcmFlag[ x0 ][
            y0 ][ 2 ] && wC <= MaxTsSize && hC <= MaxTsSize
            && !cu_sbt_flag )
          transform_skip_flag[ xC ][ yC ][ 2 ]
...
    if(chromaAvailable)
      conversion_mode_index[ xC ][ yC ]
...
}
...
```

As shown in Table 13, when the CBFs of the Cb and Cr residual signals are both zero, it is assumed that the chrominance space conversion method does not need to be performed and the associated syntax is not signaled. If at least one of the CBFs of the Cb and Cr residual signals is non-zero, the CBF values for the two converted signals, tu_c1_coded_flag and tu_c2_coded_flag, are signaled, followed by the transform_skip_flag for each signal. Then, an index, conversion_mode_index, is added to distinguish between the different chrominance space conversion methods within each implementation.

The syntax added may also vary depending on the specific operating manner of each implementation. For Implementation 1 or 2, conversion_mode_index in Table 13 may be replaced by cbcr_conversion_matrix[numComp]. For Implementation 3, the conversion_mode_index in Table 13 may be replaced by cbcr_conversion_coefficient.

### <Implementation 4-1-2> Applying Implementations 1 Through 3 in Addition to Existing Methods

In this implementation, the video decoding device may apply Implementations 1 to 3 in addition to the existing method. In this case, a new index chroma_conversion_signaling_index[x][y] may be used to distinguish how to signal the Cb and Cr components per residual block. Here, x, y are the coordinates of the top-left pixel of the current residual block. Hereinafter, the coordinates of the top-left pixel of the current residual block, x, y, are omitted and expressed as chroma_conversion_signaling_index.

The residual signal transmission method of the Cb, Cr component according to the chroma_conversion_signaling_index is shown in Table 14.

TABLE 14

| | Cb, Cr Signals Transmission |
|---|---|
| chroma_conversion_siganaling_index | Method |
| 0 | Existing Method |
| 1 | Implementation 1 |
| 2 | Implementation 2 |
| 3 | Implementation 3 |

Here, the transmission method refers to the conventional method and the chrominance space conversion method collectively.

For the method of applying Implementations 1 to 3 in addition to the traditional method, the syntax composition may be as shown in Table 15.

```
TABLE 15
transform_unit( x0, y0, tbWidth, tbHeight, treeType, subTuIndex,
chType )
...
chroma_conversion_signaling_index[ xC ][ yC ]
if(! chroma_conversion_signaling_index[ xC ][ yC ]){
  if(sps_joint_cbcr_enabled_flag && ((CuPredMode[ chType ][ x0 ][
y0 ] == MODE_INTRA
      && (tu_cb_coded_flag[ xC ][ yC ] || tu_cr_coded_flag[ xC ][
      yC ])) || (tu_cb_coded_flag[ xC ][ yC ] && tu_cr_coded_flag[
      xC ][ yC ])) && chromaAvailable)
    tu_joint_cbcr_residual_flag[ xC ][ yC ]
}else{
  if(chromaAvailable)
    conversion_mode_index[ xC ][ yC ]
}
...
```

According to Table 15, a newly introduced chroma_conversion_signaling_index is signaled to determine a transmission method for the residual signals of the Cb and Cr components. According to Table 14, if the chroma_conversion_signaling_index is 0, a method of decoding the residual signals of the Cb and Cr components or a method of decoding by applying JCCR is used, respectively, and the related conventional syntax is signaled to the video decoding device. If the chroma_conversion_signaling_index is greater than or equal to 1, a conversion_mode_index is added, which is an index that distinguishes between different chrominance space conversion methods within each implementation.

In this case, when the chrominance space conversion method is applied with a chroma_conversion_signaling_index greater than or equal to 1, the syntax components that distinguish the CBF values for the original Cb and Cr residual signals in the prior art, and whether or not the Transform Skip Mode is applied, are replaced with syntaxes for the two converted signals according to the chrominance space conversion.

The additional syntaxes may also vary depending on the specific operating manner of each implementation. For Implementation 1 or 2, conversion_mode_index in Table 15 may be replaced by cbcr_conversion_matrix[numComp]. For Implementation 3, the conversion_mode_index in Table 15 may be replaced by cbcr_conversion_coefficient. The syntax composition for this may be exemplified as shown in Table 16. Table 16 shows only the syntax composition after line 7 in Table 15.

TABLE 16

```
transform_unit( x0, y0, tbWidth, tbHeight, treeType, subTuIndex,
chType )
...
}else if(chroma_conversion_signaling_index[ xC ][ yC ]<3){
  if(chromaAvailable)
    cbcr_conversion_matrix[ xC ][ yC ][numComp]
}else{
  if(chromaAvailable)
    cbcr_conversion_coefficient[ xC ][ yC ]
}
...
```

In contrast to Table 15, the syntax may be configured in a novel way that does not follow the syntax composition of the conventional VVC technology. For example, a syntax may be organized as shown in Table 17.

```
TABLE 17
transform_unit( x0, y0, tbWidth, tbHeight, treeType, subTuIndex,
chType )
...
if( tu_cb_coded_flag[ xC ][ yC ] && treeType !=
DUAL_TREE_LUMA )
  if( sps_transform_skip_enabled_flag && !BdpcmFlag[ x0 ][ y0 ][
    1 ] && wC <= MaxTsSize && hC <= MaxTsSize &&
    !cu_sbt_flag )
      transform_skip_flag[ xC ][ yC ][ 1 ]
...
if( tu_cr_coded_flag[ xC ][ yC ] && treeType !=
DUAL_TREE_LUMA )
  if( sps_transform_skip_enabled_flag && !BdpcmFlag[ x0 ][ y0 ][
    2 ] && wC <= MaxTsSize && hC <= MaxTsSize &&
    !cu_sbt_flag )
      transform_skip_flag[ xC ][ yC ][ 2 ]
...
chroma_conversion_signaling_index[ xC ][ yC ]
if(! chroma_conversion_signaling_index[ xC ][ yC ]){
  if(sps_joint_cbcr_enabled_flag && ((CuPredMode[ chType ][ x0 ][
y0 ] == MODE_INTRA
      && (tu_cb_coded_flag[ xC ][ yC ] || tu_cr_coded_flag[ xC ][
      yC ])) || (tu_cb_coded_flag[ xC ][ yC ] && tu_cr_coded_flag[
      xC ][ yC ])) && chromaAvailable)
    tu_joint_cbcr_residual_flag[ xC ][ yC ]
}else{
  if(chromaAvailable)
    conversion_mode_index[ xC ][ yC ]
}
...
```

As shown in Table 17, after the CBF values for the two signals in the chroma channel are signaled, the transform_skip_flag for each signal is signaled. Then, a newly introduced chroma_conversion_signaling_index may be signaled, as shown in row 11 and below of Table 17, to determine a transmission method for the residual signals of the Cb and Cr components.

In accordance with Table 14, if the chroma_conversion_signaling_index is 0, a method for decoding the residual signals of the Cb and Cr components or a method for decoding by applying JCCR is used, respectively, and the associated conventional syntax is signaled to the video decoding device. If the chroma_conversion_signaling_index is greater than or equal to 1, a conversion_mode_index is added, which is an index that distinguishes between different chrominance space conversion methods within each implementation.

In this case, when the chrominance space conversion method is applied with a chroma_conversion_signaling_index greater than or equal to 1, the syntax components that distinguish the CBF values for the original Cb and Cr residual signals in the prior art, and whether or not the Transform Skip Mode is applied, are replaced with syntaxes for the two converted signals according to the chrominance space conversion.

The additional syntaxes may also vary depending on the specific operating manner of each implementation. For Implementation 1 or 2, conversion_mode_index in Table 17 may be replaced by cbcr_conversion_matrix[numComp]. For Implementation 3, the conversion_mode_index in Table 17 may be replaced by cbcr_conversion_coefficient. A syntax composition for this may be exemplified as shown in Table 16. Table 16 shows only the syntax composition after line 15 in Table 17.

### <Implementation 4-1-3> Applying Implementations 1 Through 3 to the Immediately Preceding Step of the Existing Method

In this implementation, the video decoding device may unconditionally apply the chrominance space conversion method of Implementations 1 through 3 to the step immediately preceding the existing method. The video decoding device parses the conversion_mode_index to distinguish between the different chrominance space conversion methods within Implementations 1, 2, and 3, as shown in Table 18.

TABLE 18

transform_unit( x0, y0, tbWidth, tbHeight, treeType, subTuIndex,
chType )
...
conversion_mode_index[ xC ][ yC ]
...

On the other hand, the specific operating manner of each implementation may also dictate which syntaxes are added. For Implementation 1 or 2, the conversion_mode_index in Table 18 may be replaced by cbcr_conversion_matrix[numComp]. For Implementation 3, the conversion_mode_index in Table 18 may be replaced by cbcr_conversion_coefficient.

Then, as shown in Table 11, the syntax is signaled by the CBF values of the Cb and Cr components, the tu_joint_cbcr_residual_flag, and the transform_skip_flag of the Cb and Cr components are signaled in this sequence. When chrominance space conversion is applied, the syntax elements indicating the CBF values of the original Cb and Cr residual signals in the conventional technique, and whether the transform skip mode is applied, may be replaced by the syntaxes for the two converted signals according to the chrominance space conversion.

### <Implementation 4-1-4> Selectively Applying Implementations 1 to 3 to the Step Immediately Before the Conventional Method

In this implementation, the video decoding device may selectively apply the chrominance space conversion method of Implementations 1 to 3 to a step immediately preceding the conventional method. The video decoding device may first parse chroma_conversion_signaling_index, an index that classifies the method of signaling the Cb, Cr components for each residual block, as shown in Table 19, to classify the method of signaling the residuals of the Cb, Cr components.

TABLE 19

```
transform_unit( x0, y0, tbWidth, tbHeight, treeType, subTuIndex,
chType )
...
chroma_conversion_signaling_index[ xC ][ yC ]
if( chroma_conversion_signaling_index[ xC ][ yC ]){
  if(chromaAvailable)
    conversion_mode_index[ xC ][ yC ]
}
...
```

Here, the residual signal transmission method of the Cb and Cr components according to the chroma_conversion_signaling_index is shown in Table 14 described above.

Then, when the chrominance space conversion is applied according to the value of the chroma_conversion_signaling_index, the video decoding device parses the conversion_mode_index to distinguish between different chrominance space conversion methods within the implementations 1, 2, and 3.

At this time, the syntaxes added may vary depending on the specific operating manner of each implementation. For Implementation 1 or 2, conversion_mode_index in Table 19 may be replaced by cbcr_conversion_matrix[numComp]. For Implementation 3, the conversion_mode_index in Table 19 may be replaced by cbcr_conversion_coefficient. The syntax composition for this may be represented as shown in Table 20.

TABLE 20

```
transform_unit( x0, y0, tbWidth, tbHeight, treeType, subTuIndex,
chType )
...
chroma_conversion_signaling_index[ xC ][ yC ]
if(chroma_conversion_signaling_index[ xC ][ yC ] % 3 > 0){
  if(chromaAvailable)
    cbcr_conversion_matrix[ xC ][ yC ][numComp]
}else if (chroma_conversion_signaling_index[ xC ][ yC ]==3){
  if(chromaAvailable)
    cbcr_conversion_coefficient[ xC ][ yC ]
}
...
```

After Table 19 or Table 20, the syntax is signaled by the CBF values of the Cb and Cr components, the tu_joint_cbcr_residual_flag, and the transform_skip_flag of the Cb and Cr components in this sequence, as shown in Table 11. When chrominance space conversion is applied, the syntax elements indicating the CBF values of the original Cb and Cr residual signals in the prior art, and whether the transform skip mode is applied, may be replaced by the syntaxes for the two converted signals according to the chrominance space conversion.

<Implementation 4-2> when Cb, Cr Component Signals are not Residual Signals

When the Cb, Cr component signals are predictor signals or original signals, the chrominance space conversion and inverse chrominance space conversion methods are applied at the end of the generation of each signal. For this purpose, as Implementations 1 to 3 are applied, additional syntax is signaled with respect to each implementation. On the side of the video decoding device, about the predictor, the syntax is applied immediately after the predictor generation is completed so that the inverse chrominance space conversion method is performed. About the original signals, the syntax is applied immediately after the reconstructed signal generation is completed to perform the inverse chrominance space conversion method. The chrominance space conversion method of Implementations 1 to 3 may be applied in two ways.

In the first method, the video decoding device may unconditionally apply the chrominance space conversion method of Implementations 1 to 3 to replace a conventional method. Here, the conventional method refers to decoding the residual signals of the Cb and Cr components, respectively. The syntax composition of these signals is as follows.

conversion_mode_index[ xC ][ yC ]

For example, an index, conversion_mode_index, is added to distinguish between the different chrominance space conversion methods within each implementation. The syntaxes added may also vary depending on the specific operating manner of each implementation. For Implementation 1 or 2, conversion_mode_index may be replaced by cbcr_conversion_matrix[numComp]. For Implementation 3, conversion_mode_index may be replaced by cbcr_conversion_coefficient.

In the second method, the video decoding device may apply Implementations 1 to 3 in addition to the existing method. In this case, the transmission method of the signals of the Cb and Cr components may be distinguished on a block-by-block basis by using the aforementioned index chroma_conversion_signaling_index.

The signal transmission method of the Cb, Cr component according to the chroma_conversion_signaling_index is shown in Table 14. In addition, for the method of applying Implementations 1 to 3 in addition to the existing method, the syntax composition may be as shown in Table 21.

TABLE 21

chroma_conversion_signaling_index[ xC ][ yC ]
if (chroma_conversion_signaling_index)
conversion_mode_index[ xC ][ yC ]

According to Table 21, the newly introduced chroma_conversion_signaling_index is signaled to determine the transmission method for the Cb and Cr component signals. According to Table 14, if chroma_conversion_signaling_index is 0, the conventional method is used for transmitting the Cb and Cr component signals to the next step without using the chrominance space conversion method. If chroma_conversion_signaling_index is 1 or more, an index, conversion_mode_index, is added to distinguish between different chrominance space conversion methods within each implementation.

On the other hand, the syntax added may also vary depending on the specific operating manner of each implementation. For Implementation 1 or 2, conversion_mode_index in Table 21 may be replaced by cbcr_conversion_matrix[numComp]. For Implementation 3, the conversion_mode_index in Table 21 may be replaced by cbcr_conversion_coefficient. A syntax composition for this may be exemplified as shown in Table 22.

TABLE 22

```
chroma_conversion_signaling_index[ xC ][ yC ]
if(chroma_conversion_signaling_index[ xC ][ yC ]<3){
  cbcr_conversion_matrix[ xC ][ yC ][numComp]
}else{
  cbcr_conversion_coefficient[ xC ][ yC ]
}
...
```

### <Implementation 5> Signaling Whether the Chrominance Space Conversion Method is Used at a Higher Level

This implementation is a method of signaling for allowing the application or non-application of methods to be decided at a higher level: whether the chrominance space conversion methods of Implementations 1 through 3 are to be applied, and whether the syntax signaling method in Implementation 4 is to be applied.

For example, the sps_conversion_signaling_enable_flag may be signaled by the video encoding device at a higher level, such as the Sequence Parameter Set (SPS), to determine whether the methods of Implementations 1 through 4 are to be used. If the sps_conversion_signaling_enable_flag is 0, Implementations 1 through 4 are not applied. The absence of that flag is inferred to be 0. If sps_conversion_signaling_enable_flag is 1, Implementations 1 through 4 are applied. Without any additional conditions, the sps_conversion_signaling_enable_flag may be signaled as follows.

[SPS level]

sps_conversion_signaling_enable_flag

Alternatively, the sps_conversion_signaling_enable_flag may be signaled under certain conditions in the video. For example, the sps_conversion_signaling_enable_flag may be signaled depending on conditions after setting the conditions by using chroma_format_idc, which is an index that classifies the color format of the video. The color formats according to chroma_format_idc may be classified as shown in Table 23.

TABLE 23

| chroma_format_idc | Color Format |
|---|---|
| 0 | 4:0:0 |
| 1 | 4:2:0 |
| 2 | 4:2:2 |
| 3 | 4:4:4 |

For example, the decision conditions for whether to transmit the sps_conversion_signaling_enable_flag according to the chroma_format_idc may be set as shown in Equation 26.

$$color\_format \_condition = ! chroma\_format \_idc ? 1 : 0 \qquad Equation 26$$

$$color\_format \_condition = chroma\_format \_idc > 1 ? 1 : 0$$

Herein, color_format_condition is a flag indicating whether the aforementioned decision conditions are satisfied. According to the first condition, if the color format is not 4:0:0, the flag is transmitted at a higher level; or, according to the second condition, if the color format is 4:2:2 or 4:4:4, the flag is transmitted at a higher level. In addition to the above example conditions, various other conditions may be set, and the resulting syntax composition is shown in Table 24.

TABLE 24
SPS level

if (color_format_condition)
sps_conversion_signaling_enable_flag

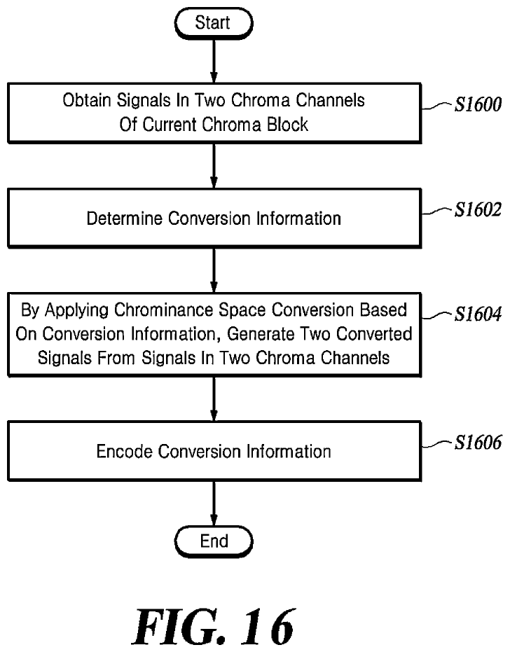

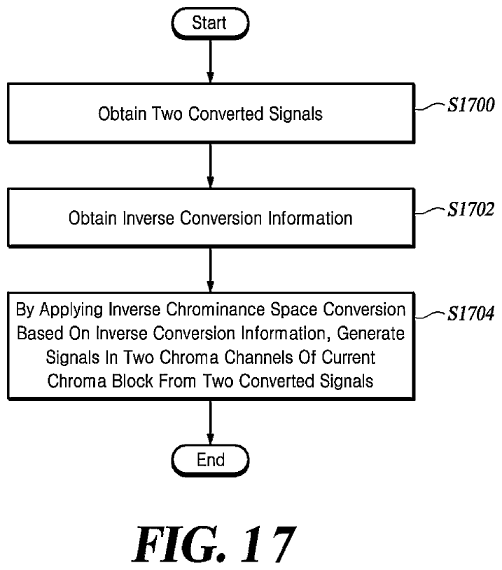

Hereinafter, a method of converting a current chroma block and a method of inversely converting a current chroma block is described with reference to FIGS. 16 and 17.

FIG. 16 is a flowchart of a method performed by the video encoding device for converting a current chroma block, according to at least one embodiment of the present disclosure.

The video encoding device obtains signals in two chroma channels of the current chroma block (S1600). Here, the signals in the two chroma channels Cb, Cr may be original signals, predictors, or residual signals of the current chroma block.

The video encoding device determines the conversion information in terms of optimizing the coding efficiency (S1602).

In Implementation 1 described above, the conversion information may be a value of a combination matrix. For Implementation 2 described above, the conversion information may be values of the combination matrix and the offset matrix. For Implementation 3 described above, the conversion information may be a coefficient.

The video encoding device applies a chrominance space conversion based on the conversion information to generate two converted signals from the signals in the two chroma channels (S1604).

In Implementation 1 described above, the video encoding device generates the two converted signals by multiplying the signals in the two chroma channels by a combination matrix, as shown in Equation 14.

In Implementation 2 described above, the video encoding device multiplies the signals in the two chroma channels by the combination matrix and adds the offset matrix to generate the two converted signals, as shown in Equation 18.

For Implementation 3 described above, the video encoding device sets one chroma signal of the signals in the two chroma channels to be one converted signal of the two converted signals. Further, the video encoding device subtracts the one converted signal of the converted signals multiplied by a coefficient from the remaining chroma signal to generate the remaining converted signal, as shown in Equation 24.

The video encoding device encodes the conversion information (S1606).

In Implementation 1 described above, the encoded conversion information may be values of a combination matrix or an index indicating the combination matrix. Alternatively, the encoded conversion information may be the values of an inverse combination matrix or an index indicating the inverse combination matrix.

If the conversion information is an index indicating a combination matrix, the video encoding device may derive the index from a preset list of combination matrices. If the conversion information is an index indicating an inverse combination matrix, the video encoding device may derive the index from a preset list of inverse combination matrices.

In Implementation 2 described above, the encoded conversion information may be values of a combination matrix and an offset matrix, an index of the combination matrix and values of the offset matrix, values of the combination matrix and an index directing the offset matrix, or an index directing the combination matrix and the offset matrix. Alternatively, the conversion information that is encoded may be the values of the inverse combination matrix and the offset matrix, the index of the inverse combination matrix and the values of the offset matrix, the values of the inverse combination matrix and the index that points to the offset matrix, or the index that points to the inverse combination matrix and the offset matrix.

If the conversion information is an index indicative of an offset matrix, the video encoding device may derive the index from a preset list of offset matrices.

In Implementation 3 described above, the conversion information being encoded may be a coefficient or an index indicative of a coefficient. If the conversion information is an index indicating a coefficient, the video encoding device may derive the index from a preset list of coefficients.

FIG. 17 is a flowchart of a method performed by the video decoding device for inversely converting a current chroma block, according to at least one embodiment of the present disclosure.

The video decoding device obtains two converted signals (S1700). Here, the two converted signals are generated by a chrominance space conversion of the video encoding device.

The video decoding device obtains the inverse conversion information (S1702). Here, the inverse conversion information corresponds to the conversion information utilized in the chrominance space conversion.

In Implementation 1 described above, the inverse conversion information may be values of a combination matrix or an index indicating the combination matrix. Alternatively, the inverse conversion information may be the values of an inverse combination matrix or an index indicating the inverse combination matrix.

If the inverse conversion information is an index referring to a combination matrix, the video decoding device decodes the index from the bitstream and obtains the values of the combination matrix from a preset list by using the index. Alternatively, if the inverse conversion information is an index referring to an inverse combination matrix, the video decoding device decodes the index from the bitstream and obtains the values of the inverse combination matrix from a preset list by using the index.

Meanwhile, after the values of the combination matrix are obtained as the inverse conversion information, the video decoding device may generate an inverse combination matrix from the values of the combination matrix.

In Implementation 2 described above, the inverse conversion information may be values of the combination matrix and the offset matrix, an index of the combination matrix and values of the offset matrix, values of the combination matrix and an index indicative of the offset matrix, or an index indicative of the combination matrix and the offset matrix. Alternatively, the inverse conversion information may be values of the inverse combination matrix and the offset matrix, an index of the inverse combination matrix and values of the offset matrix, values of the inverse combination matrix and an index indicating the offset matrix, or an index indicating the inverse combination matrix and the offset matrix.

If the inverse conversion information is an index indicating the offset matrix, the video decoding device decodes the index from the bitstream and obtains the values of the offset matrix from a preset list by using the index.

In Implementation 3 described above, the inverse conversion information may be a coefficient or an index indicating the coefficient.

If the inverse conversion information is an index indicating the coefficient, the video decoding device decodes the index from the bitstream and obtains the values of the coefficient from the preset list by using the index.

The video decoding device applies an inverse chrominance space conversion based on the inverse conversion information to generate signals in the two chroma channels of the current chroma block from the two converted signals (S1704). Here, the signals in the two chroma channels Cb, Cr may be the original signals, the predictors, or the residual signals of the current chroma block.

For Implementation 1 described above, the video decoding device generates the signals in the two chroma channels by multiplying the two converted signals by an inverse combination matrix, as shown in Equation 16.

For Implementation 2 described above, the video decoding device generates the signals in the two chroma channels by multiplying the two converted signals by an inverse combination matrix and adding an offset matrix, as shown in Equation 20.

For Implementation 3 described above, the video decoding device sets one converted signal of the two converted signals to be one chroma signal of the signals in the two chroma channels, as shown in Equation 25. Further, the video decoding device generates the remaining chroma signal by multiplying the converted signal by a coefficient and adding the remaining converted signal.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for inversely converting a current chroma block, the method comprising:
obtaining two converted signals that are generated by a chrominance space conversion by a video encoding device;
obtaining inverse conversion information corresponding to conversion information that is utilized for the chrominance space conversion; and
generating signals in two chroma channels of the current chroma block from the two converted signals by applying an inverse chrominance space conversion that is based on the inverse conversion information.

2. The method of claim 1, wherein the signals in the two chroma channels include:
original signals of the current chroma block, predictors of the current chroma block, or residual signals of the current chroma block.

3. The method of claim 1, wherein obtaining the inverse conversion information includes:
obtaining, as the inverse conversion information, an inverse combination matrix which is an inverse matrix of a combination matrix that is the conversion information.

4. The method of claim 3, wherein obtaining the inverse conversion information includes:
decoding, from a bitstream, an index indicative of the combination matrix;
obtaining, by using the index, values of the combination matrix from a preset list; and
calculating the inverse combination matrix from the values of the combination matrix.

5. The method of claim 3, wherein obtaining the inverse conversion information includes:
obtaining, from a bitstream, values of the combination matrix; and
calculating the inverse combination matrix from the values of the combination matrix.

6. The method of claim 3, wherein obtaining the inverse conversion information includes:
decoding, from a bitstream, an index indicative of the inverse combination matrix; and
obtaining, by using the index, values of the inverse combination matrix from a preset list.

7. The method of claim 3, wherein obtaining the inverse conversion information includes:
obtaining, from a bitstream, values of the inverse combination matrix.

8. The method of claim 1, wherein obtaining the inverse conversion information includes:
obtaining as the inverse conversion information an inverse combination matrix and an offset matrix, the inverse combination matrix being an inverse matrix of a combination matrix in the conversion information, and the offset matrix being included in the conversion information that is utilized for the chrominance space conversion.

9. The method of claim 8, wherein obtaining the inverse conversion information includes:
decoding, from a bitstream, an index indicative of the offset matrix; and
obtaining, by using the index, values of the offset matrix from a preset list.

10. The method of claim 8, wherein obtaining the inverse conversion information includes:
decoding, from a bitstream, values of the offset matrix.

11. The method of claim 8, wherein generating the signals in the two chroma channels includes:
multiplying the two converted signals by the inverse combination matrix and adding the offset matrix to generate the signals in the two chroma channels.

12. The method of claim 1, wherein obtaining the inverse conversion information includes:
obtaining, as the inverse conversion information, a coefficient which is contained in the conversion information that is utilized for the chrominance space conversion.

13. The method of claim 12, wherein obtaining the inverse conversion information includes:
decoding, from a bitstream, an index indicative of the coefficient;
obtaining, by using the index, values of the coefficient.

14. The method of claim 12, wherein obtaining the inverse conversion information includes:
decoding, from a bitstream, a value of the coefficient.

15. The method of claim 12, wherein generating the signals in the two chroma channels comprises:
setting one converted signal of the two converted signals to one chroma signal of the signals in the two chroma channels, and multiplying the one converted signal by the coefficient and adding a remaining converted signal to generate a remaining chroma signal.

16. A method performed by a video encoding device for converting a current chroma block, the method comprising:
obtaining signals in two chroma channels of the current chroma block;
determining conversion information;
generating two converted signals from the signals in the two chroma channels by applying a chrominance space conversion that is based on the conversion information; and
encoding the conversion information.

17. The method of claim 16, wherein the signals in the two chroma channels include:
original signals of the current chroma block, predictors of the current chroma block, or residual signals of the current chroma block.

18. The method of claim 16, wherein the conversion information includes:
a combination matrix, an offset matrix with the combination matrix, or a coefficient, which is for applying the chrominance space conversion.

19. A computer-readable recording medium storing a bitstream generated by a video encoding method, the video encoding method comprising:
obtaining signals in two chroma channels of a current chroma block;
determining conversion information;
generating two converted signals from the signals in the two chroma channels by applying a chrominance space conversion that is based on the conversion information; and
encoding the conversion information.
